(19) United States
(12) Patent Application Publication
(10) Pub. No.: US 2003/0084608 A1
(43) Pub. Date: May 8, 2003

(54) Floral display vase with multiple foam elements

(76) Inventors: Pete F. Garcia, Atlanta, GA (US); William R. Palombo, Portsmouth, RI (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/287,126

(22) Filed: Nov. 4, 2002

Related U.S. Application Data
(60) Provisional application No. 60/332,797, filed on Nov. 6, 2001.

(51) Int. Cl. A01G 5/00; A47G 7/00

(52) U.S. Cl. 47/41.12

(57) ABSTRACT

A floral display includes small pieces of colored foam positioned within a vase, enabling the vase to hold more water than prior displays and allows easier insertion of weak flower stems. In addition, the floral display enhances the decorative nature of the floral display by facilitating easy use of color foam pieces that coordinates with the flower colors used in the display. The foam elements are small in comparison to the size of the vase.

### CROSS-REFERENCE TO RELATED APPLICATIONS

This application claims the priority benefit of U.S. Provisional Patent Application Serial No. 60/332,797, filed Nov. 6, 2001, which is hereby incorporated herein by reference in its entirety.

### TECHNICAL FIELD

The present invention relates generally to floral displays and more particularly to a floral display that has a vase or the like and small foam elements.

### BACKGROUND OF THE INVENTION

In the past, “water absorbing floral foam” has been used in forming fresh floral displays (arrangements). To form the display using the water absorbing floral foam, a florist cuts a piece of the foam to size and shape it to fit within a vase, and adds water to the vase to soak into the foam. After placing the foam in the vase, the stems of cut flowers and/or plants can be inserted into the foam. In this way, the foam supports the flowers stems and enables an upright display of the flowers. In addition, the water within the flower foam provides moisture to the flower stems or plant stems and prolongs the flowers' and/or plant's life. The stems of fragile flowers, such as tulips, can break in trying to force the stems into the foam. In response to this problem, some floral designers have constructed conventional floral displays using a less rigid foam for these weaker stems. Alternatively, larger stems may warrant using wire in addition to the foam for supporting the display.

Despite the development in the area of floral displays, conventional solutions do not provide an entirely satisfactory solution for displaying plants with various stem sizes and strengths. In addition, using a single piece of foam within a vase can considerably limit the amount of water that the vase can hold. Thus, a need still exists for a floral display that can effectively support stems of varying size and strength. It is to the provision of such a floral display that the present invention is primarily directed.

### SUMMARY OF THE INVENTION

The present invention meets the needs described above in a more decorative and functional floral display that includes a plurality of relatively small foam elements. The invention includes relatively small pieces of foam positioned within the vase that allow easier insertion of weak flower stems. By using small foam elements, the present invention also limits waste created by cutting a block of floral foam to fit a particular vase size. Finally, the present invention enhances the decorative nature of the floral display by facilitating easy use of color foam pieces that coordinate with the flower colors used in the display.

Generally described, the invention is a floral display for supporting at least one stem. The invention includes a transparent (or at least translucent) container for receiving the stem. A plurality of geometric foam elements is positioned within the container. Collectively, the foam elements are operable for at least partially supporting the stem either directly or indirectly.

Preferably, the foam elements are small, having an average volume of between about 0.1 and 9 cubic inches. More preferably, the foam elements have an average volume of between about 0.5 and 3 cubic inches. In a preferred form the foam elements are cubic in shape, although other shapes can be employed.

By virtue fo their small size in relation to the interior of the vase, the individual foam elements are more easily displaced to make way for a stem being inserted therein. In this way, the small foam elements allow relatively easy insertion of stems. By contrast, if one were to sue a single, large foam element within a vase, the user would typically be required to force the stem into the foam, which can be difficult with weak stems. By using the small, loose foam elements, the floral display of the present invention is more adept at receiving relatively weak stems therein.

In view of the foregoing, it will be appreciated that a floral display according to the present invention avoids the drawbacks of prior systems. The specific techniques and structures employed by the invention to improve over the drawbacks of the prior systems and accomplish the advantages described herein will become apparent from the following detailed description of the embodiments of the invention and the appended drawings and claims.

### BRIEF DESCRIPTION OF THE DRAWINGS

FIG. 1A is a side view of a floral display according to a first preferred form of the invention and shown having a plurality of small foam elements.

FIG. 1B is a side view of foam elements illustrating alternative shapes for the foam elements of FIG. 1A.

FIG. 2 is a side view of the floral display of FIG. 1A shown with water added and surrounding some of the foam elements.

FIG. 3 is a side view of the floral display of FIG. 1A depicting the insertion of plant stems into the display and multi-color foam elements.

FIG. 4 is a perspective view of a transparent bag used in packaging the multicolor foam elements of FIG. 1A prior to use.

FIG. 5 is a side view of an alternative construction of the floral display of FIG. 1A illustrating foam elements in combination with a foam log.

### DETAILED DESCRIPTION OF THE PREFERRED EMBODIMENTS

In describing the embodiments of the present invention, specific terminology is employed for the sake of clarity. The invention, however, is not intended to be limited to the specific terminology so selected.

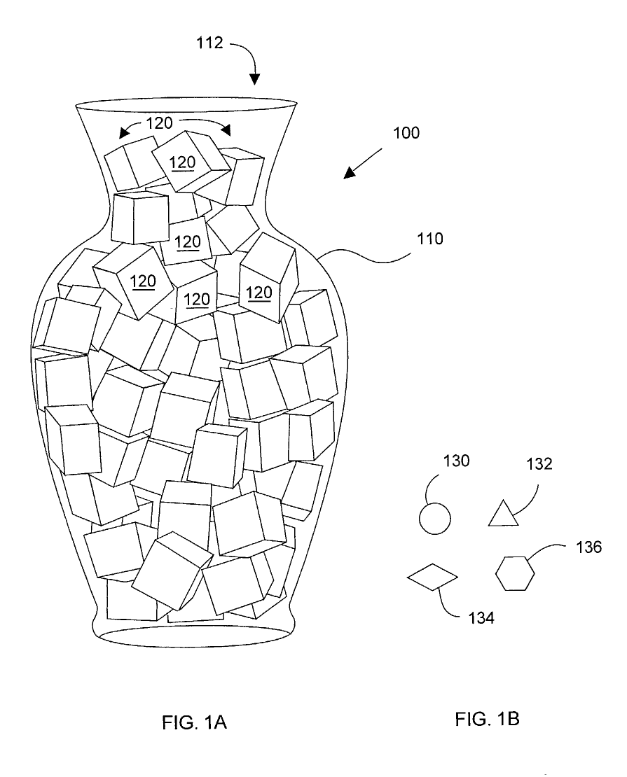

FIG. 1A is a side view of a floral display illustrating a first embodiment of the invention. The floral display 100 includes a container such as a vase 110 with an opening 112. The vase 110 can be formed from a substantially transparent material such as glass, plastic, or some other suitable material. Preferably, the vase is at least translucent such that the contents are easily visible. Most preferably, the vase is substantially transparent. The floral display 100 also includes several, preferably dozens, of three-dimensional foam elements 120. The dimensions of the foam elements 120 are chosen so as to facilitate easy insertion into the vase 110 through the opening 112. The number of elements 120 inserted into the vase 110 can vary depending upon design constraints. For example, the floral display 100 can include a large number of elements 120 when used with flowers with fairly short stems. Also, the size of the foam elements influences the number of elements. The smaller the foam elements, the greater the number employed, typically. As shown in FIG. 1A, the foam elements 120 are relatively small cubes (small relative to the size of the interior of the vase). Suitable sizes for cubes has been found to be from about 0.5 to about 3 inches, preferably about 0.75 to about 1.5 inches, and most preferably about 1 inch. If other shapes are utilized, suitable sizes have an equivalent volume of from about 0.1 to about 9 cubic inches, preferably from about 0.4 to about 4 cubic inches, and most preferably about 1 cubic inch. If the foam elements are of varying sizes, these ranges should be considered the average size of the foam elements.

Turning now to FIG. 1B, foam elements 120 are shown illustrating some alternative shapes for the foam elements. Instead of the cubic foam elements 120 shown in FIG. 1A, the foam elements 120 can take a variety of shapes, such as a sphere 130 or a pyramid 132. Alternatively, the shapes could be a diamond 134 or a hexagon 136. Alternatively, the geometric foam elements 120 could be formed in other shapes including a cylinder, or some other suitable polygon. Moreover, the foam elements can be irregular shapes and can all have the same shape or different shapes can be mixed. Though not shown, the geometric foam elements 120 could be of varying sizes.

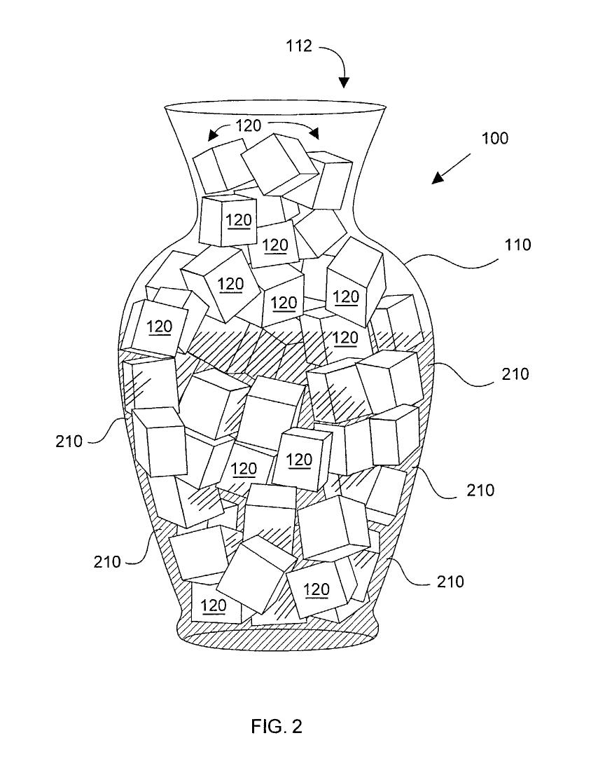

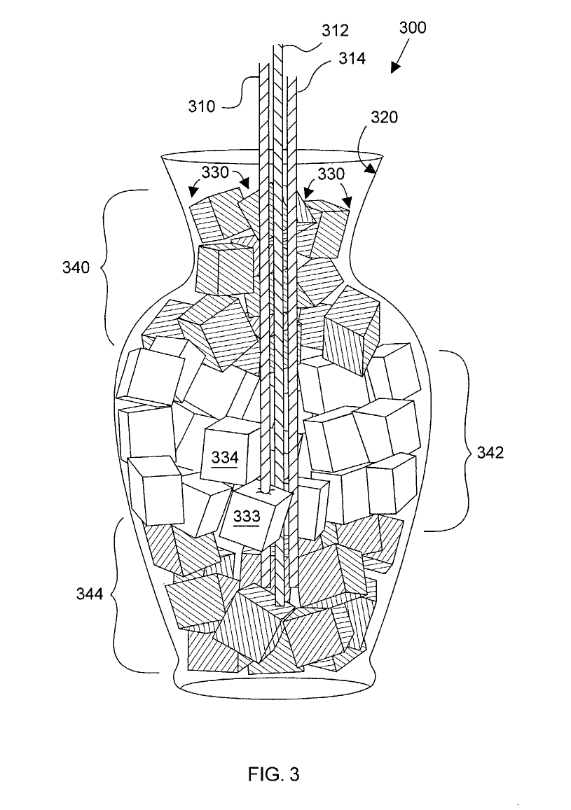

FIG. 2 is a side view of the floral display 100 illustrating water 210 surrounding the foam elements 120. The foam elements 120 can be “wet foam” used for fresh flowers and plant stems or “dry foam” (which absorbs water) for silk flowers and dried flowers. The foam elements can be made of fire-resistant, open-cell phenolic foam, urea foam, polyurethane foam, or some other suitable material that is non-toxic to plant life. The small size of the foam elements 120 creates space between them and allows the water 210 to surround these foam elements. Consequently, more water 210 can be stored in the vase 110 using the small foam elements 120 than if a single piece of foam was used. The use for the water held by the foam elements 120 will become more apparent with the description of FIG. 3. In this manner, the foam elements 120 can effectively support the stems of plants while at the same time increasing the available water stored in the vase for consumption by the flower stem or plant stem.

FIG. 3 is a side view of floral display of FIG. 1 depicting the insertion of plant stems within the vase and into the midst of multi-color foam elements. The floral display 300 includes plant stem 310, plant stem 312, and plant stem 314. Though not shown, these stems could be the stems of various flowers such as roses, tulips, carnations, sunflowers, or other plants. By inserting those stems into the vase 320, the geometric foam elements 330 begin shifting, allowing the stems 310-314 to proceed downwardly toward the bottom of the vase 320. On occasion, the stem 310 actually pierces a geometric foam element, see element 333, although most simply are jostled out of the way as the stem moves downwardly. The stems 310-314 can even pierce several of the geometric foam elements 330. Water within the foam elements 330 and in the interstitial spaces is held proximate to the stem 310 and prolongs the life of that stem. In addition, the geometric foam elements 330 can either support the stems 310-314 directly or indirectly. For example, the foam element 333 supports the stem 310 directly. In contrast, the foam element 334 supports the stem 310 indirectly. For plants with larger stems, more foam elements 330 can be added to the vase 320. In this manner, the floral system 300 can effectively support plant stems of varying size.

In addition, the foam elements 330 can enhance the decorative nature of the display 300. The geometric elements 330 can be divided into layers with a color associated with each layer that coordinate with the colors of the flowers for stems 310-314. The layer 340 could be green, the layer 342 could be yellow, and the layer 344 could be orange 346. For this example, each of the foam elements 330 in layer 340, layer 342, and layer 344 would be green, yellow, and orange respectively. Alternatively, the colors could be red, purple, blue, brown, black, or some other suitable color. Consequently, the colors of the geometric elements 330 can be selected so as to coordinate with the colors in the flowers with the stems 310-314. Thus the foam elements 330 enhance the decorative nature of the display 300.

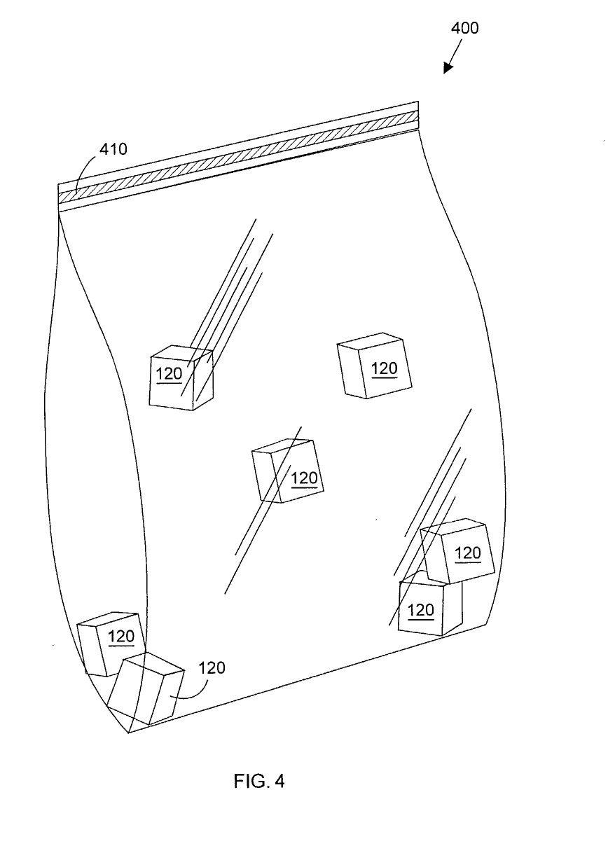

As shown in FIG. 4, a bag 400 can be used in packaging the foam elements 120. The bag 400 may include a closure 410 that facilitates sealing the bag 400. Generally, the bag 400 is composed of a translucent, or partially transparent, material that easily identifies the color of the foam elements 120. While the bag 400 illustrates an airtight packaging means, alternative packaging means may be used such as bags used with twist tie closures, transparent shrink wrap, storage compartments, or some other suitable packaging means.

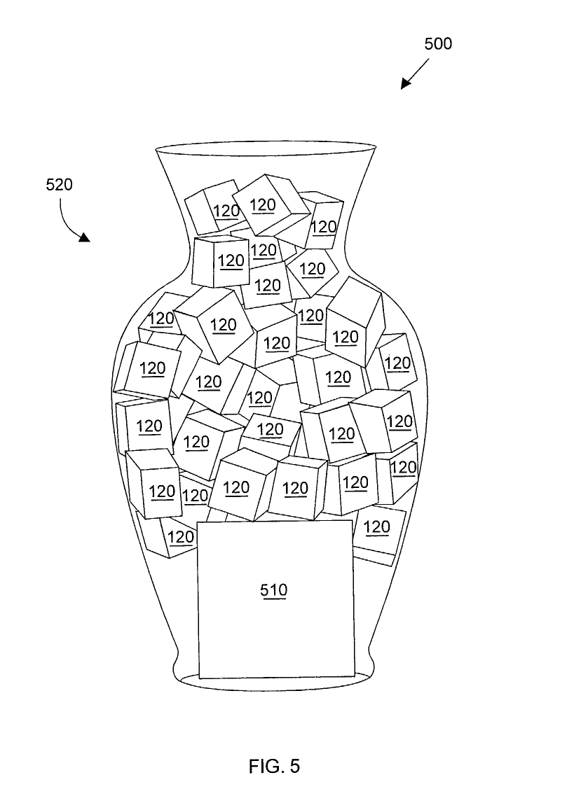

FIG. 5 illustrates is an alternative construction illustrating a floral display 500 that uses foam elements 120 in combination with a foam brick 510. Using the foam brick 510 reduces the number of foam elements 120 needed to fill the container 520. Like the foam elements 120, the color of the foam brick 510 can correspond to the color of the plant stems, not shown. In addition, including the foam elements 120 on top of and around the foam brick 510 facilitates securing stems of varying lengths. For example, the foam elements 120 can secure short plant stems. In contrast, the foam elements 120 and the foam brick 510 can secure longer plant stems.

In view of the foregoing, it will be appreciated that the present invention provides a more decorative and functional floral display that uses relatively small foam elements. While the invention has been disclosed in preferred forms for illustration purposes, those skilled in the art will readily recognize that many modifications, additions, and deletions can be made therein without departing from the spirit and scope of the invention as set forth in the following claims.

The invention claimed is:

1. A floral display for supporting a plurality of stems in a liquid comprising:
a transparent or at least translucent container for receiving the stems and the liquid; and
a plurality of foam elements positioned within the container, wherein each of the foam elements is relatively small in relation to the container and collectively are operable for supporting the stem, and wherein some of the foam elements are of a first color and others of the foam elements are of a second color different from the first color.

2. The floral display of claim 1 wherein the foam elements have an average equivalent volume of from about 0.1 to about 9 cubic inches.

3. The floral display of claim 1 wherein the foam elements have an average equivalent volume of from about 0.4 to about 4 cubic inches.

4. The floral display of claim 1 wherein the foam elements have an average equivalent volume of about 1 inch.

5. The floral display of claim 1 wherein the foam elements are in the shape of a cube having an average size of about 0.5 to about 3 inches.

6. The floral display of claim 1 wherein the foam elements are in the shape of a cube having an average size of about 0.75 to about 1.5 inches.

7. The floral display of claim 1 wherein the foam elements are in the shape of a cube having an average size of about 1 inch.

8. The floral display of claim 1 wherein the different color foam elements are arranged in different color layers.

9. The floral display of claim 1 wherein yet others of the foam elements are of a third color different from the first color and the second color.

10. The floral display of claim 9 wherein the foam elements are arranged in three generally distinct color layers.

11. The floral display of claim 1 wherein the foam elements are geometric shapes.

12. The floral display of claim 11 wherein the each of the geometric foam elements are cubes.

13. The floral display of claim 1 wherein the foam elements are of a uniform size and shape.

14. A floral support for use with a plant stem and container, the support comprising:
a plurality of multicolor non-toxic foam elements for supporting at least one fragile plant stem, the foam elements for use with a container having an open interior that receives the stem, wherein the foam elements are positioned within the open interior, are relatively small in comparison to the open interior, and are collectively operable for at least partially supporting the fragile stem.

15. The decorative support element of claim 14 wherein the foam elements have an average equivalent volume of from about 0.4 to about 4 cubic inches.

16. The floral support of claim 14 wherein the foam elements have an average equivalent volume of about 1 cubic inch.

17. The floral support of claim 14 wherein the foam elements are in the shape of a cube having an average size of about 0.5 to about 3 inches.

18. The floral support of claim 14 wherein the foam elements are in the shape of a cube having an average size of about 0.75 to about 1.5 inches.

19. The floral support of claim 14 wherein the foam elements are in the shape of a cube having an average size of about 1 inch.

20. The floral support of claim 14 wherein at least some of the foam elements are of a first color and at least some others of the foam elements are of a second color different from the first color.

21. The floral support of claim 20 wherein the different color foam elements are arranged as different color layers.

22. The floral support of claim 20 wherein at least some of the foam elements are of a third color different from the first color and the second color.

23. The floral support of claim 22 wherein the first portion of foam elements comprise a first layer, the second portion of foam elements comprise a second layer, and the third portion of foam elements comprise a third layer.

24. The floral support of claim 20 wherein the different color layers includes colors selected from the color group consisting of yellow, orange, red, purple, blue, brown, and black.

25. The floral support of claim 14 wherein the foam elements comprise geometric shapes.

26. The floral support of claim 25 wherein the geometric foam elements comprise a shape selected from the group consisting of rectangular shapes, hexagonal shapes, diamond shapes, and spherical shapes.

27. The floral support of claim 14 wherein the container comprises a vase.

28. The floral support of claim 14 wherein the foam elements are packaged in a bag.

29. A floral display device for supporting at least one stem comprising:
a transparent or at least translucent container for receiving the stem; and
a plurality of relatively small foam elements positioned within the container, wherein the foam elements are small in relation to the container and are arranged in at least two layers, and wherein foam elements in the first layer are of a first color, and wherein foam elements in the second layer are of a second color different from the first color.

30. The floral display device of claim 29 further comprising a third layer of foam elements of a third color different from the first color and the second color.

31. The floral display device of claim 29 wherein the foam elements comprises simple geometric shapes and the container comprises a vase.
